(19) United States
(12) Patent Application Publication
(10) Pub. No.: US 2009/0314769 A1
(43) Pub. Date: Dec. 24, 2009

(54) HOB ALLOWING THE TEMPERATURE OF A CULINARY ARTICLE TO BE DETECTED

(75) Inventors: Jocelyn Bonnel, Vions (FR); Noël Burais, Villeurbanne (FR)

Correspondence Address: WINSTON & STRAWN LLP;PATENT DEPARTMENT, 1700 K STREET, N.W., WASHINGTON, DC, 20006, US

(73) Assignee: SEB S.A.

(21) Appl. No.: 12/307,607

(22) PCT Filed: Jul. 6, 2007
(86) PCT No.: PCT/FR07/01158

§ 371 Date: Apr. 16, 2009

(30) Foreign Application Priority Data
Jul. 6, 2006 (FR) 0606175

(51) Int. Cl. H05B 6/12

(52) U.S. Cl. 219/627

(57) ABSTRACT

The invention relates to a hob (200) suitable for receiving a culinary article (100) and including a measurement system (203) which comprises means (220) for measuring the temperature of the article (100) and control means (240). According to the invention the measuring means (220) comprise an electrical circuit (219) possessing at least one inductive element (221) configured so as to induce a magnetic field on the article (100) which includes electrically conductive heat-sensitive means (130) that transmit a signal to the control means (240), the value of said signal being representative of the impedance (Z) of the circuit (119), the impedance being dependent on the resistivity (p) of the heat-sensitive means (130), and the control means (240) including at least one model corresponding to the thermal behaviour of this resistivity (P) and being configured so as to convert the value of the transmitted signal into a temperature.

The present invention relates to the field of hobs, in particular those allowing the temperature of a culinary article to be detected. From a general point of view, it is a question of determining the temperature of a culinary article so as to optimise the cooking of a food, or to protect the cooking utensil, independently of the size of the article.

More precisely, the invention relates to a hob adapted to receive a culinary article and comprising a measurement system which is adapted to measure the temperature of the culinary article, and which comprises measuring means and control means.

Such a hob is well known to persons skilled in the art, in particular through the example given thereof in the document of the prior art JP 5344926. This document describes a cooking system comprising a culinary article and a hob. The culinary article is equipped with a heat-sensitive means, and with a secondary coil forming a closed circuit with the heat-sensitive means. The hob is provided with a primary coil, a means of generating high frequencies inducing a current in the secondary coil, and a temperature-detection means which determines the temperature of the culinary article according to the level of current flowing in the primary coil.

The drawback of such a configuration is that it requires on the one hand integration of a coil in the removable container, and on the other hand positioning of the secondary coil and the heat-sensitive means inside a protective housing in the centre of the upper face of the bottom of the container.

The document DE 4413979 is also known. This document discloses a cooking system comprising a culinary article and a hob. The culinary article comprises in its bottom a sensor cooperating with a second sensor situated in or on the hob. The sensor of the culinary article is essentially a so-called “binary” multilayer ceramic sensor making it possible to detect the reaching of target temperatures by sudden modification of the dielectric constant at the target temperature. The hob comprises a set of sensors, or electrodes, connected capacitively to the dielectric of the sensor situated in the bottom of the culinary article.

The drawback of such a configuration is that it is dedicated to capacitive measurements and the measurement of the temperature is not fine because of the constraints of the target values.

Finally, the document US 2005/0258168 discloses a hob for grilling foodstuffs. This induction hob is provided with a tray on which the foodstuffs to be grilled are placed, the tray being provided with a ferromagnetic material for temperature measurement.

The drawback of such a configuration is that it requires a particular steric arrangement for the positioning of the inductive heating means and the measuring means. Moreover, it requires two measuring coils for one heating coil.

The aim of the present invention is to remedy these drawbacks by proposing a simple device that is easy to use and maintain.

With this aim in mind, the hob according to the invention, furthermore in accordance with the preamble cited above, is essentially characterised in that the measuring means comprise an electrical circuit which possesses at least one inductive type element configured to induce a magnetic field towards the culinary article and which transmits to the control means a signal resulting from the action of the induced magnetic field on electrically conductive heat-sensitive means of the culinary article, the control means comprising at least one model corresponding to the thermal behaviour of the heat-sensitive means, and being configured to convert into a temperature, using the model, the value of the transmitted signal.

Thus, the temperature of the culinary article can be measured accurately, given that the resistivity varies continuously as a function of the temperature and this measurement is more representative of the temperature of the foods given that it is made directly on the culinary article and not on the hob.

Measurement of the temperature can be carried out during heating of the culinary article by remote measuring means in the hob without contact with the article. By virtue of the direct processing by the electronics of the hob, it is not necessary to introduce these electronics (for measurement, transmission, etc.) into a handle of the culinary article or to connect a temperature probe in contact with the culinary article and the electronics of the hob. Regulation of the temperature of the culinary article does not involve any signal transmission, in the sense that no means of communication by infrared or radio is necessary between the hob and the article.

Furthermore, the temperature measurements made are discrete measurements whereof the frequency is advantageously periodic and can be chosen, perhaps even modulated, according to the temperature or the type of non-ferromagnetic material.

Furthermore, the culinary article can be used on any conventional type of heating means (induction, radiant, gas, etc.), without risk of damaging the heat-sensitive means.

Other characteristics and advantages of the present invention will emerge more clearly from a reading of the following description given by way of an illustrative and non-limiting example and produced with reference to the accompanying figures in which:

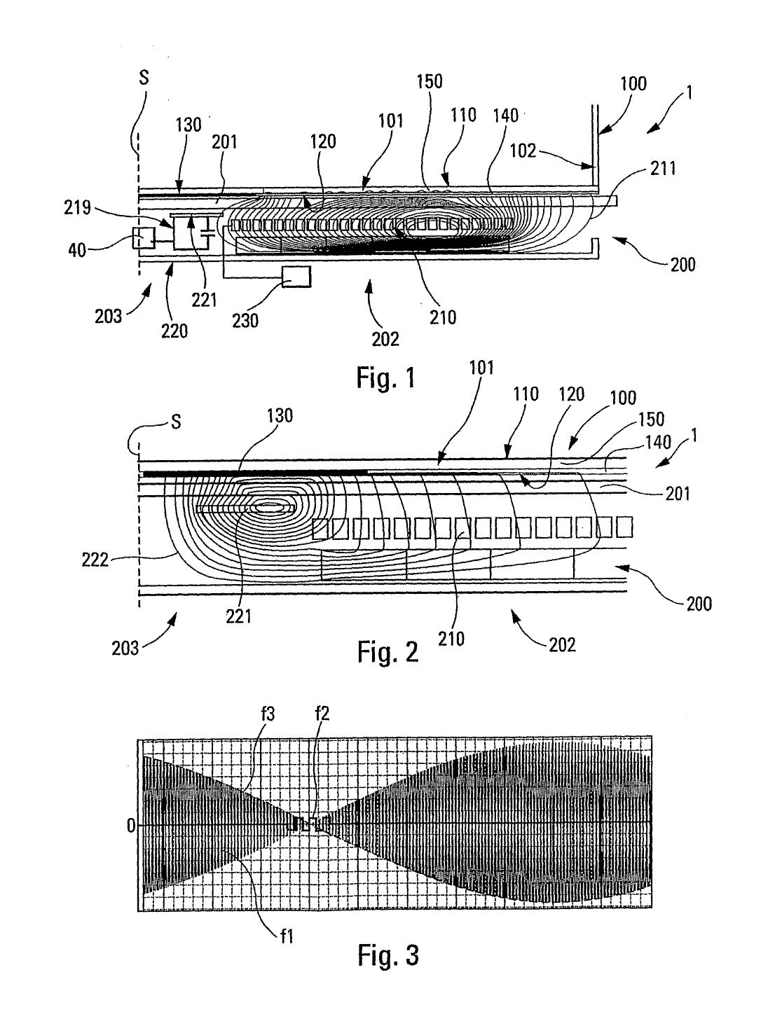

FIG. 1 depicts a cross-section of part of a cooking system (in operation) comprising a culinary article in accordance with one embodiment of the present invention and a hob, the heating means of the hob being in the heating state and the measuring means being in the off mode;

FIG. 2 is similar to FIG. 1, the heating means being in the off state and the measuring means in induction mode; and

FIG. 3 depicts the general principle of the change in voltage in the measuring means and the change in current in the heating means.

As can be seen in FIGS. 1 and 2, a cooking system 1 for cooking foods comprises a culinary article 100 adapted to receive foods or a cooking fluid (water, oil, etc.), for example a frying pan or saucepan, and a hob 200 adapted to support the culinary article 100 and transmit to the latter the energy necessary for cooking the food it contains.

As depicted in FIGS. 1 and 2, the culinary article 100 comprises a basic body 150, made from a heat-conducting basic material, for example aluminium.

This basic body generally defines the geometrical structure of the culinary article and can serve as a support for a possible internal and/or external coating (enamel, paint, Teflon coating, etc.).

The culinary article 100 defines a volume for receiving the food to be cooked which is delimited by a bottom 101 and a side wall 102. The bottom 101 of the culinary article 100, here circular in shape, possesses an internal face (or upper face) 110 intended to be in contact with the foods and an external face (or lower face) 120 intended to be in contact with the hob 200.

At least part of at least one of the faces 110, 120 of the bottom 101 has a substantially flat appearance, so as to provide the stability of the culinary article 100 when the latter is put down on a horizontal surface (hob 200, table, etc.). Here, the faces 110, 120 of the bottom 101 are completely flat and the thickness of the bottom 101 is constant.

Here, the bottom 101 is formed principally by the material of the basic body 150.

The culinary article 100 comprises heat-sensitive means 130 that conduct electricity. These heat-sensitive means are intended to allow the temperature of the culinary article 100 to be determined. Preferably, the material chosen for the heat-sensitive means 130 has a high variability of its resistivity p over a given temperature range (preferably from 20° C. to 300° C.), which makes it possible to obtain accurate temperature measurements. Furthermore, in order to facilitate the calculations allowing the temperature to be determined, it is preferable for the variation in resistivity ρ as a function of temperature (in the given temperature range) to be linear, and, in order to obtain great accuracy in measuring the temperature, for the temperature coefficient C_{T} to be high. Furthermore, preferably and for reasons described later, the heat-sensitive means 130 are non-ferromagnetic means. For all these reasons, in the present embodiment, the heat-sensitive means are made of titanium.

The heat-sensitive means 130 are integrated into the bottom 101 of the culinary article 100. In the present embodiment, the heat-sensitive means 130 have a constant thickness. Here, the heat-sensitive means 130 are formed by a heat-sensitive element 130 (an insert integrated into the basic body 150). Preferably and for reasons described later, the heat-sensitive means 130 (here, a face of the insert 130) constitute part of the external wall 102 of the bottom 101 of the culinary article 100 (here the central part), as depicted in FIGS. 1 and 2.

In the present embodiment, the heat-sensitive means 130 have a shape with a rotational symmetry whereof the axis S is perpendicular to the plane of the bottom 101. In this case, the insert 130 has the appearance of a disc that is concentric with the bottom 101 of the culinary article 100.

Furthermore, in the present embodiment, as illustrated in FIGS. 1 and 2, the culinary article 100 also comprises ferromagnetic means 140. These ferromagnetic means 140 are intended to allow the heating of foods when the hob 200 on which the culinary article 100 is resting is a magnetic induction hob, and they are configured to convert an incident magnetic field (depicted in FIG. 1 by field lines 211) coming from the hob 200 into heat, by Joule effect (induced by Foucault currents).

In the present embodiment, the ferromagnetic means 140 are integrated into the bottom 101 of the culinary article 100, and more precisely into the basic body 150. In the present embodiment, the ferromagnetic means 140 extend in a ring 140. They can be, for example, in the form of a grid or hot-bonded capsules.

According to the invention, the heat-sensitive means 130 and the ferromagnetic means 140 are arranged with respect to each other so that the heat generated by the ferromagnetic means 140 is transmitted by thermal conduction to the heat-sensitive means 130. Here, the ring 140 made of ferromagnetic material is in contact with the circular insert 130 made of heat-sensitive material that it surrounds.

As depicted in FIGS. 1 and 2, the hob 200 comprises a receiving surface 201 adapted to receive the culinary article 100 (more precisely, the lower face 120 of its bottom 101). The hob 200 comprises at least one cooking zone (in this case, only one).

The hob 200 comprises a heating system 202 and a temperature measurement system 203.

The heating system 202 comprises heating means 210 and regulation means 230. Each cooking zone has associated with it heating means 210 that are specific to it.

The regulation means 230, for example a microcontroller and its adapted program, allow, for example, regulation of the heating means 210 around a setpoint, or activation of a timer, etc.

In the present embodiment, as depicted in FIGS. 1 and 2, the heating means 210 are inductive. To that end, they comprise an inductor, in the case in point an inductive heating coil 210. Each cooking zone comprises at least one inductive heating coil 210 (in this case, only one). Furthermore, the hob 200 comprises first thermal protection means that make it possible to thermally protect the heating means 210 when they are inductive.

In the present embodiment, the heating system 202 is configured so that the heating means 210 provide heating sequenced over time and go successively and alternately into a heating state in which they generate and transmit the cooking energy, and into an off state in which they no longer generate this energy. In this case, as the heating means 210 are inductive, they are supplied by an alternating current of frequency f₁ amplitude-modulated by a frequency f₃, the zero (and the adjacent area as explained below) of the modulation corresponding to the off state and the rest to the heating state. A typical frequency f₁ is for example from 18 to 25 kHz. A typical modulation is of frequency f₃ equal to 50 Hz or 60 Hz (100 Hz or 120 Hz after rectification).

The temperature measurement system 203 comprises measuring means 220 and control means 240.

The measuring means 220 comprise an electrical circuit 219 having at least one element 221 of inductive type, independently of the type (inductive or not) of the heating means 210. In the present embodiment, the inductive type element is an inductor 221, in the case in point, an inductive measuring coil 221.

As can be seen in FIGS. 1 and 2, the inductive measuring coil 221 is disposed in the centre of the inductive heating coil 210.

The magnetic field (depicted in FIG. 2 by field lines 222) generated by the inductive measuring coil 221 is of much smaller amplitude than that generated by the inductive measuring coil 210 and does not allow heating of a ferromagnetic material by induction.

The inductive measuring coil 221 makes it possible to measure by induction the magnitude of the current flowing in the heat-sensitive element 130 of the culinary article 100 when the latter is positioned on the receiving surface 201. This is because the inductive measuring coil 221 can be considered as the primary circuit of a transformer whilst the heat-sensitive means 130 of the culinary article 100 are the secondary circuit thereof.

The measurement principle is based on the variation in the impedance Z of the electrical circuit 219 (in this case an RLC circuit comprising the inductive measuring coil 221 and a capacitor of capacitance C mounted in series with the inductive measuring coil 221) as a function of the variation in temperature of the heat-sensitive elements 130. The measuring coil 221 is characterised by an inductance L_{B} (whereof the variation as a function of the temperature is sufficiently small as to be negligible) and a resistance R_{B}. The value of the impedance Z of the electrical circuit 119 (primary circuit) is a function of the resistance R_{B} of the inductive measuring coil 221 (whereof the value is known) and of the resistance R_{S} of the secondary circuit formed by the heat-sensitive material 130 (whereof the value depends on the temperature). The magnitude I of the current flowing in the inductive measuring coil 221 corresponds to the values of the voltage U applied to the electrical circuit 119 and of the impedance Z, according to the equation U=Z*I.

The measurement of the magnitude of the current I flowing in the inductive measuring coil 221 makes it possible to determine the impedance Z of the electrical circuit 119 and therefore the resistance R of this circuit 119, and to deduce therefrom the resistance R_{S} of the heat-sensitive means 130 and therefore their resistivity ρ (the dimensions of these means being known) and their temperature.

The control means 240 make it possible to determine the temperature of the culinary article 100 from the measurement of the magnitude I of the current flowing in the inductive measuring coil 221, the measuring means 220 transmitting to the control means 240 a signal whereof the value is representative of the impedance Z of the circuit 119 (in the case in point, the magnitude I of the current flowing in the inductive measuring coil 221).

The control means 240 comprise at least the model of the thermal behaviour of the resistivity ρ of the heat-sensitive material 130 inserted in the bottom of the culinary article 100. It is easy to understand that the use of heat-sensitive means 130 with a temperature coefficient C_{T} that is constant (actually or according to an acceptable approximation) in the operating temperature range of the culinary article 100 makes it possible to greatly facilitate the determination of the temperature from a value of the resistivity ρ, the model then being linear. In order to carry out this determination, the control means 240 advantageously comprise a microprocessor.

In order to facilitate determination of the temperature (more precisely, in order to facilitate correlation between the variation in the resistance R and in the current I), it is advantageous for the inductive measuring coil 221 to be supplied with a voltage U (in this case a square-wave voltage) whereof the frequency f₂ corresponds to the resonant frequency fᵣ of the electrical circuit 119 which is equal to 1/(2π√L_{B}·C): at this frequency, the impedance Z of the electrical circuit 119 is equal to its resistance R, and the applied voltage U and the current I in this circuit 119 are proportional (U=R*I). In reality, the capacitor C is chosen according to the available supply frequency f₂ and the inductance L_{B} of the inductive measuring coil 221. The inductive measuring coil 221 therefore makes it possible to measure a variation in resistance R which can be correlated with a variation in temperature of the culinary article 100.

Furthermore, the resistance R_{S} of the heat-sensitive means 130 depends among other things on the depth of penetration δ of the magnetic field created by the inductive measuring coil 221, and this depth of penetration δ depends on both the resistivity ρ and the magnetic permeability μᵣ of the heat-sensitive means 130, in accordance with the formula δ=√(ρ/π·μ₀·μᵣ·f), where μ₀ is the magnetic permeability of vacuum and f is the frequency of the inductive measuring coil 221 (here, f₂). However, if these two properties δ and μᵣ vary at the same time, it is extremely difficult to connect the variation in the resistance R measured by the inductive measuring coil 221 (in fact the current I) with the temperature of the culinary article 100. Therefore, it is easily understood that it is highly advantageous for the heat-sensitive means 130 to be non-ferromagnetic, as the magnetic permeability μᵣ can then be considered to be 1 and not dependent on the temperature, unlike a ferromagnetic material.

In reality, once the nature of the non-ferromagnetic material of the heat-sensitive means 130 has been determined, their thickness E is chosen according to the frequency f₂ of the supply voltage U of the inductive measuring coil 221 so as to be greater than the depth of penetration δ associated with this frequency f₂. Vice versa, the frequency f₂ of the supply voltage U of the inductive measuring coil 221 can be determined according to the thickness E of the heat-sensitive means 130 and the desired depth of penetration δ. In the present embodiment, the titanium non-ferromagnetic heat-sensitive means 130 have a thickness of 1.2 mm for a frequency f₂ of 50 kHz.

Another advantage of using a non-ferromagnetic material as the heat-sensitive means 130 is that, in this case, the inductance L_{B} (known) of the inductive measuring coil 221 varies little in its presence.

Thus, in this particular case, the only element varying as a function of temperature in the impedance Z of the circuit 119 is the resistivity ρ of the heat-sensitive means 130 (and therefore the only property of the heat-sensitive means 130 to play a part in the measurement of the temperature when they are made from a non-ferromagnetic material is the variation in their resistivity ρ), which makes it possible to easily obtain an accurate measurement. In order to improve the measurement, the heat-sensitive means 130 are advantageously positioned opposite the inductive measuring coil 221. Moreover, the surface area of the heat-sensitive means 130 is preferably greater than that of the inductive measuring coil 221, which increases the reliability of the measurement.

Thus, measurement of the temperature of the culinary article 100 is carried out independently of the heating of this article, and can take place as soon as it is put down on the hob 200, outside of any activation of the heating means 210, and independently of the size of the culinary article 100.

Furthermore, in the present embodiment, the hob 200 comprises second thermal protection means which make it possible to thermally protect the measuring means 220. These second thermal protection means can be either specific, or constituted by the first thermal protection means.

In the present embodiment, as the heating means 210 are inductive, in order to not interfere with the measurement of the temperature of the culinary article, this is done preferably in the vicinity of the zero-crossing of the modulation of the supply current of the heating means 210, so as to avoid induction effects between the inductive heating means 210 and the inductive measuring means 220, even if the respective frequencies f₁, f₂ are preferably substantially different (the frequencies can be different or not).

To that end, and in order to not be damaged, during operation the inductive measuring coil 221 goes successively and alternately into off mode in which it is supplied by a zero voltage (open circuit), and into induction mode in which it is supplied by the square-wave voltage U of frequency f₂). FIG. 3 depicts, for the same arbitrary unit of time, the change in voltage at the terminals of the inductive measuring coil 221 according to a frequency f₂ and the change in the modulated current in the inductive heating coil 210 according to a frequency f₁ modulated by a frequency f₃.

This schematic and simulated figure principally illustrates the differences between the frequencies f₁, f₂ of the inductive heating 210 and measuring 221 coils, and the fact that the inductive measuring coil 221 is supplied only in the vicinity of the zero-crossing of the modulation of the current in the inductive heating coil 210.

In the present embodiment, unlike FIG. 3 depicting the operating principle, in the vicinity of the zero-crossing of the modulation, when the voltage of the inverter generating the modulation frequency f₃ falls below a certain limit (for example 30-40 V), said inverter (by construction) turns off (the arches of the modulation are not as regular as in FIG. 3). Therefore there is a time (one to two milliseconds for a modulation at 50 Hz) around the theoretical zero-crossing of the modulation where the field of the inductive heating coil 210 is zero and therefore where the heating means 210 are in their off state. This time is sufficient to perform the measurement.

In the preferred embodiment, the hob 200 comprises additional measuring means (not depicted) adapted to measure the temperature of the receiving surface 201, for example NTC type means (means whereof the electrical resistivity is a function of a Negative Temperature Coefficient). These additional measuring means (conventionally used in hobs 200) are connected to the temperature measurement system 203 (and more particularly to the control means 240) and make it possible to correlate the measurement made by the inductive measuring coil 221 with the measurement they make and to calibrate the temperature measurement system 203. This temperature comparison can take place only at the beginning of the heating of the culinary article 100 or at any time during this heating.

The detection of a temperature by the inductive measuring coil 220 and/or by the additional measuring means also makes it possible to determine the reaching of a maximum target temperature generating a halt of heating and thus protecting the culinary article 100.

During use, in the present embodiment, the culinary article 100 is positioned on the induction hob 200. Following activation of the heating means 210, for example by selection of a function or a programme (simmering, boiling water, cooking with oil, fat-free cooking, etc.), the inductive heating coil 210 produces a magnetic field which induces currents in the ferromagnetic means 140 of the bottom 101 of the culinary article 100, which, by Joule effect, heats these ferromagnetic means 140 and, by thermal conduction, the rest of the culinary article 100, including the heat-sensitive insert 130.

With the variation in temperature, the resistivity ρ and the resistance R_{S} of the heat-sensitive means 130 change, as do the resistance R and the impedance Z of the electrical circuit 119. On account of the use of a non-ferromagnetic material as the heat-sensitive means 130 and the supplying of the inductive measuring coil 221 with a voltage U whereof the frequency f₂ corresponds to the resonant frequency fᵣ of the electrical circuit 119, the magnitude I sent by the measuring means 220 to the control means 240 allows the latter to easily determine the temperature of the culinary article 100 from this magnitude I.

Furthermore, the temperature measurement system 203 can also be used for other functions such as detecting the presence of a culinary article 10 on the hob 200, perhaps even its centring, or recognizing the type of culinary article 100 or its compatibility with the hob 200, combined for example with generating an error signal or a signal for inhibiting the heating means. This is because the presence of a metallic material in proximity to the measuring means 220 modifies the impedance of the circuit 119, and this modification is translated by the control means 240 without necessarily converting this impedance modification into a temperature.

The present invention is not limited to the present embodiment.

As regards the bottom of the culinary article, it is possible for its faces to have a slight concavity, for its thickness to not be constant, for its shape to have an appearance other than circular, for example an oval or rectangular (square) appearance.

As regards the material used for making the heat-sensitive means, it is possible to use metals such as titanium, bismuth, molybdenum (in particular molybdenum disilicide MoSi2), platinum, copper, aluminium, magnesium, zinc or nickel, or alloys of these metals or else metallic ceramics, austenitic stainless steel or non-ferrous enamels.

As regards the heat-sensitive means, they can have a shape other than a disc; for example forming an assembly comprising at least one ring or a number of rings concentric with the centre of the bottom of the culinary article and preferably thermally interconnected. They can have embossing or cut-outs (preferably the cut-outs are situated in the plane of the bottom of the culinary article). They can also, at least in part, be covered by a transparent material having a magnetic field, such as an enamel or a paint, which forms at least part of the lower face of the bottom of the culinary article which allows the culinary article to be easily cleaned without risk of damaging the heat-sensitive means.

The heat-sensitive means might not form an insert, but be deposited in the form of layer(s), for example by serigraphy or heat spraying. They can also be formed by several superposed non-ferromagnetic materials, for example colaminated or deposited in layers.

As regards the ferromagnetic means, they can be at a distance from the heat-sensitive means, as long as the heat-sensitive means are not thermally insulated.

As regards the hob, this could comprise several cooking zones, each of which is respectively equipped with a measuring coil. In this case, the bob can comprise only a single measurement system for all the cooking zones, connected by multiplexing to the different measuring coils of the cooking zones.

As regards the control means, these can comprise several thermal behaviour models, each model corresponding to a given heat-sensitive material, so as to increase the flexibility of use of the hob. Moreover, one thermal behaviour model can comprise several thermal behaviour schemes for a plurality of measurement frequencies, which then makes it possible to recognise the heat-sensitive material of the culinary article. Moreover, the control means could be coupled with the regulation means, for example in the form of an electronic circuit, or integrated together in a microprocessor.

As regards the measurement system, the supply voltage of the measuring means can be in the form of a multifrequency excitation, or in the form of Dirac pulse(s).

In order to obtain a measurement of the temperature in the vicinity of at least one zero-crossing of the modulation of the current, in particular if the time for determining the temperature is relatively long, it is possible to perform a measurement every N zero-crossings of the modulation, with N a natural integer (for example every five or ten seconds with a modulation at 50 Hz) and to turn off the inverter for one arch (a half-period) so as to have a zero current in the inductive heating coil without interfering with the heating of the article.

1. Hob (200) adapted to receive a culinary article (100) and comprising, on the one hand, a heating system (202) which comprises heating means (210) and, on the other hand, a measurement system (203) which is adapted to measure the temperature of the culinary article (100), and which comprises measuring means (220) and control means (240), characterised in that the measuring means (220) comprise an electrical circuit (219) which possesses at least one inductive type element (221) distinct from the heating means (210) and configured to induce a magnetic field towards the culinary article (100) comprising electrically conductive heat-sensitive means (130) whereof the resistivity (ρ) varies with temperature, the electrical circuit (219) transmitting to the control means (240) a signal whereof the value is representative of the impedance (Z) of the circuit (119) dependent on the resistivity (ρ) of the heat-sensitive means (130) on account of the action of the magnetic field induced by the inductive type element (221) of said measuring means (220) on these heat-sensitive means (130), the control means (240) comprising at least one model corresponding to the thermal behaviour of the resistivity (ρ) of the heat-sensitive means (130), and being configured to convert into a temperature, using the model, the value of the transmitted signal.

2. Hob (200) according to claim 1, wherein the magnetic field generated by the inductive type element (221) of the measuring means (220) does not allow heating of a ferromagnetic material by induction.

3. Hob (200) according to claim 1, characterised in that the signal transmitted to the control means (240) is the magnitude (I) of the current passing through the inductive type element (221) of said measuring means (220).

4. Hob (200) according to claim 1, characterised in that the inductive type element (221) of said measuring means (220), in induction mode, is supplied by a voltage (U) whereof the frequency (f₂) corresponds to the resonant frequency (fᵣ) of the electrical circuit (119), said electrical circuit (119) being provided with a capacitor.

5. Hob (200) according to claim 4, characterised in that the capacitor of the electrical circuit (119) is mounted in series with the inductive type element (221) of said measuring means (220).

6. Hob (200) according to claim 1, characterised in that the electrical circuit (119) is configured so that the signal transmitted to the control means (240) depends only on the resistivity (ρ) of the heat-sensitive means (130) when the latter are non-ferromagnetic.

7. Hob (200) according to claim 1, characterised in that the electrical circuit (219) is configured so that the depth of penetration (δ) of the magnetic field induced by the inductive type element (221) of said measuring means (220) is less than the thickness (E) of the heat-sensitive means (130) of culinary articles (100) compatible with the hob (200).

8. Hob (200) according to claim 1, characterised in that, during operation, the inductive type element (221) of said measuring means (220) goes successively and alternately into induction mode in which it is supplied by a voltage (U), and into off mode in which it is not supplied.

9. Hob (200) according to claim 8, characterised in that the heating system (202) is configured so that the heating means (210) generate energy to the culinary article (100) sequenced over time, and cooperates with the measuring system (203) so that the inductive type element (221) of said measuring means (220) is in induction mode when the heating means (210) are in the off state and is in the off state when the latter are in the heating state.

10. Hob (200) according to claim 9, characterised in that the heating means (210) are of inductive type and are supplied by an amplitude-modulated alternating current, the zero of the modulation corresponding to the off state of the heating means (210) and the rest to the heating state.

11. Hob (200) according to claim 10, characterised in that the inverter generating the modulation turns off when its voltage falls below a minimum value.

12. Hob according to claim 10, characterised in that the inverter generating the modulation is turned off regularly every N zero-crossings of the modulation for a half-period of the modulation.

13. Hob (200) according to claim 1, characterised in that it comprises additional measuring means adapted to measure the temperature of the receiving surface (201) of the hob (200) on which the culinary article (100) is resting and connected to the measuring system (203) so as to calibrate the latter.

14. Cooking system (1) adapted to cook a food, characterised in that it comprises a hob (200) in accordance with claim 1, and a culinary article (100) whereof the bottom (101) comprises heat-sensitive means (130) made from materials that conduct electricity whereof the resistivity (ρ) varies with temperature.

15. Cooking system (1) according to claim 14, characterised in that the electrical circuit (119) is configured so that the signal transmitted to the control means (240) depends only on the resistivity (ρ) of the heat-sensitive means (130), the heat-sensitive means (130) of the culinary article (100) being made from non-ferromagnetic materials.

16. Cooking system (1) according to claim 14, characterised in that the electrical circuit (219) is configured so that the depth of penetration (δ) of the magnetic field induced by the inductive type element (221) of said measuring means (220) is less than the thickness (E) of the heat-sensitive means (130) of culinary articles (100) compatible with the hob (200), the thickness (E) of the heat-sensitive means (130) of the culinary article (100) being greater than the depth of penetration (δ) of the magnetic field induced by the inductive type element (221) of said measuring means (220) of the hob (200).

17. Cooking system (1) according to claim 14, characterised in that during operation, the inductive type element (221) of said measuring means (220) goes successively and alternately into induction mode in which it is supplied by a voltage (U), and into off mode in which it is not supplied; the heating system (202) is configured so that the heating means (210) generate energy to the culinary article (100) sequenced over time, and cooperates with the measuring system (203) so that the inductive type element (221) of said measuring means (220) is in induction mode when the heating means (210) are in the off state and is in the off state when the latter are in the heating state; and the heating means (210) are of inductive type and are supplied by an amplitude-modulated alternating current, the zero of the modulation corresponding to the off state of the heating means (210) and the rest to the heating state, the culinary article (100) comprising ferromagnetic means (140) arranged with respect to the heat-sensitive means (130) so as to transmit to the latter the heat they produce under the effect of the magnetic field induced by the heating means (210) of the hob (200).

18. Cooking system (1) according to one of claim 14 characterised in that the hob (200) comprises at least one cooking zone with which there is associated an inductive type element (221) of said measuring means (220), the heat-sensitive means (130) being arranged in the bottom (101) of the culinary article (100) so as to be opposite this inductive type element (221) when the culinary article (100) is disposed on the cooking zone.

19. Cooking system (1) according to claim 17 characterised in that the ferromagnetic means (140) are arranged in the bottom (101) of the culinary article (100) so as to be opposite the inductive type heating means (210) when the culinary article (100) is disposed on the cooking zone.

20. Cooking system (1) according to claim 19, characterised in that, for each cooking zone, an inductive type element (221) of said measuring means (220) is surrounded by the inductive type heating means (210).
